(19) United States
(12) Patent Application Publication
(10) Pub. No.: US 2011/0209306 A1
(43) Pub. Date: Sep. 1, 2011

(54) DEVICE FOR SUSPENDING A SLIDING DOOR

(75) Inventors: Christian Pritz, Amstetten (AT); Peter Jetzinger, Amstetten (AT)

(73) Assignee: KNORR-BREMSE GMBH, Mödling (AT)

(21) Appl. No.: 13/125,738

(22) PCT Filed: Oct. 30, 2009
(86) PCT No.: PCT/EP2009/007791

§ 371 Date: May 3, 2011

(30) Foreign Application Priority Data
Oct. 30, 2008 (AT) A 1697/2008

(51) Int. Cl. E05D 15/06

(52) U.S. Cl. 16/91

(57) ABSTRACT

The invention relates to the suspension of a door leaf of a sliding door in rail-bound, mass transportation vehicles, such as underground railways, passenger train cars, means of local public transportation, and the like. The suspension mechanism includes carrying rollers in a carrying rail arranged in the upper region of the door leaf or above the door leaf. The invention includes a steel insert having an at least substantially circular track inserted into the carrying rail; the carrying rollers are designed as steel rollers having a concave cross-sectional shape on the running surface, and an adjustment roller is provided, which abuts the adjustment surface of the carrying rail opposite of the steel insert under preload.

### CROSS REFERENCE TO RELATED APPLICATIONS

The present application claims the benefit of priority to International Patent Application No. PCT/EP2009/007791 filed 30 Oct. 2009, which further claims the benefit of Austrian Patent Application No. A 1697/2008 filed 30 Oct. 2008, the contents of which are incorporated herein by reference in their entirety.

### FIELD OF THE INVENTION

Disclosed embodiments relate to a means of suspending a door leaf of a sliding door in rail-bound means of mass transportation, such as subways, passenger train cars, means of local public transportation, etc., by means of supporting rollers in a supporting rail arranged in the upper region of the door leaf or above the door leaf.

### BACKGROUND

Door suspending means of this type should be designed to be as free from play as possible in order to guarantee quiet running of the door. At the same time, however, the entire door suspending means comprising the supporting rail which runs in the upper door region or above the door and is mounted on the car body, and rollers which are connected to the door leaf and run on the supporting rail, for which purpose use is also made of guides which act at least in the lower region of the door leaf, should permit a certain degree of mobility, in particular rotatability about the axis of the supporting rail, in order to be able to compensate for tolerances, elastic and plastic deformation of the car body, of the door leaf or of the guides themselves.

Conventionally, these conditions have only been incompletely satisfied and most suspending means operate with trough-shaped rails in which toroidal rollers run, and the freedom from play has hitherto been approximated as readily as possible by an adjustment roller having been provided, offset in the direction of the rail axis from the actual supporting roller, the adjustment roller being offset in height with respect to the supporting roller and virtually completely avoiding the raising of the supporting roller, since the adjustment roller then strikes an upper boundary surface of the supporting rail.

In a variant embodiment known from practice, the supporting rail has, in the load region, a convex cross section on which a supporting roller having a concave running surface runs, as a result of which the friction is intended to be reduced and the possibility of the angular offset improved.

Another problem in all of the previously known door guides is that the supporting rail is an aluminum section, and in that the supporting rollers consist of plastic. This does not appear to be a problem at first sight, but even high-quality plastics have a tendency to absorb water and, in the process, change their geometrical dimensions, and therefore, depending on the operating conditions (summer-winter, day-night, sunny side-shade side, etc.), there is a repeated tendency either for the rollers to become wedged and to be damaged by overcoming the wedge, or for the seat, which is geometrically as accurate as possible but is never actually free from play, to become too loose, which may result in noisy running of the door and in turn, due to the impacts caused during the noisy running, to differing types of damage.

### SUMMARY

Disclosed embodiments address these issues in the conventional technology and provide a door guide which does not have the above-mentioned problems. According to the disclosed embodiments, a steel insert having at least a substantially circular track is embedded in the supporting rail, in that the supporting rollers are designed as steel rollers having a concave cross-sectional shape on the running surface, and in that an adjustment roller is provided, the adjustment roller bearing under pre-stress against the adjustment surface of the supporting rail, the adjustment surface lying opposite the steel insert.

### BRIEF DESCRIPTION OF THE FIGURES

Disclosed embodiments are explained in more detail below with reference to the drawings, in which

FIG. 1 shows a first embodiment according to the invention in side view and section normally to the supporting rail, and

FIGS. 2 and 3 each show variant embodiments.

### DETAILED DESCRIPTION

In accordance with the disclosed embodiments two supporting rollers and one tensioning roller may be provided per fastening point of the door leaf to the supporting rail. The effect achieved by this measure is an extremely accurate guide, in which the steel insert in the supporting rail creates the possibility of also producing the supporting roller from steel and of thus maintaining the geometrical dimensions with a high degree of accuracy. The adjustment roller can either consist of plastic, in which case the pre-stressing may be achieved by elastic deformation of the adjustment roller, or the adjustment roller may also be a steel roller, with the mounting then potentially being spring-loaded.

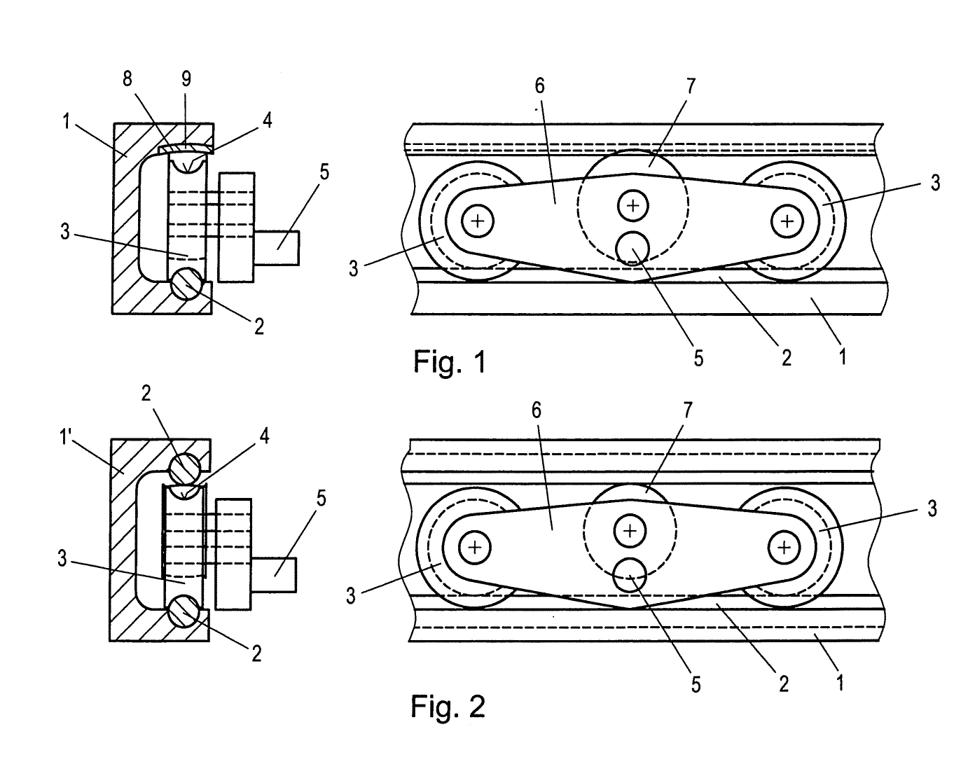

FIG. 1 shows a door guide according to the invention in a schematic side view and in section normally to the supporting rail. The door guide has a supporting rail 1 which generally has a C-shaped cross section. The lower region of the supporting rail 1 has a steel insert 2 which is circular in cross section. During the production of the supporting rail 1, which consists of aluminum, the steel insert can be incorporated in the manner of a lost core into the extruded section; it is also possible to produce the supporting rail 1 without the steel insert and to press the latter subsequently by means of elastic deformation into the depression created during the production of the supporting rail 1. The use of adhesive, etc. is also possible here.

The provision of the steel insert 2 makes it possible, according to the invention, to manufacture the supporting rollers 2, or at least the running surfaces thereof, from steel. In the section of the left subfigure, it is clear that the running surface 4 of the supporting roller 1 is of concave design in the meridian section through the supporting roller 3, wherein this shape of the running surface 4 corresponds in size and shape to the cross-sectional shape of the steel insert 2.

It is, therefore, ensured that the supporting rollers 3 and, therefore, the door leaf can be pivoted within certain limits about the center point of the steel insert 2, thus enabling the required option for changing the door leaf angle (not illustrated) to be achieved.

As emerges from the right subfigure of FIG. 1, two supporting rollers 3 arranged on a common roller rocker 6 may be used per suspending point 5 for the door leaf. An adjustment roller 7, the rolling surface of which makes contact with the supporting rail 1 in the adjustment region 8, is arranged, with the axis offset vertically, in the region of the suspending point 5 on the roller rocker 6. The adjustment region 8 here is the region which lies at least substantially opposite the steel insert 2 in the C-shaped cross section of the supporting rail 1.

In the exemplary embodiment illustrated, an adjustment plate 9 is also provided in the adjustment region 8 in the aluminum supporting rail 1, and the adjustment roller 7 has a slightly convex running surface matched to the running surface of the adjustment plate. The curvature of the interacting running surfaces is selected here such that the center point of the curvature lies in the center point of the steel insert 2. This avoids distortions during the angular offset of the door leaf. If a certain restoring moment is desired, the center of curvature of the running surfaces of the adjustment plate 9 and of the adjustment roller 7 should be located somewhat above the center point of the steel insert 2; a center point located lower than the center point is not taken into consideration because of the tendency which then arises of pivoting the door leaf out of the desired position.

It is not necessary for the supporting rail 1 to be provided with an adjustment plate 9; if a plate insert of this type is omitted, the adjustment roller 7 is advantageously composed of plastic so as not to damage the rail because of the pre-stress.

In the exemplary embodiment illustrated, the pre-stressing takes place by means of elastic deformation of the roller rocker 6 or, if an adjustment roller made of plastic is used, by means of elastic deformation of the adjustment roller 7; of course, the adjustment roller 7 may also be guided in a resiliently suspended bearing, with the springs of the bearing taking over the pre-stressing.

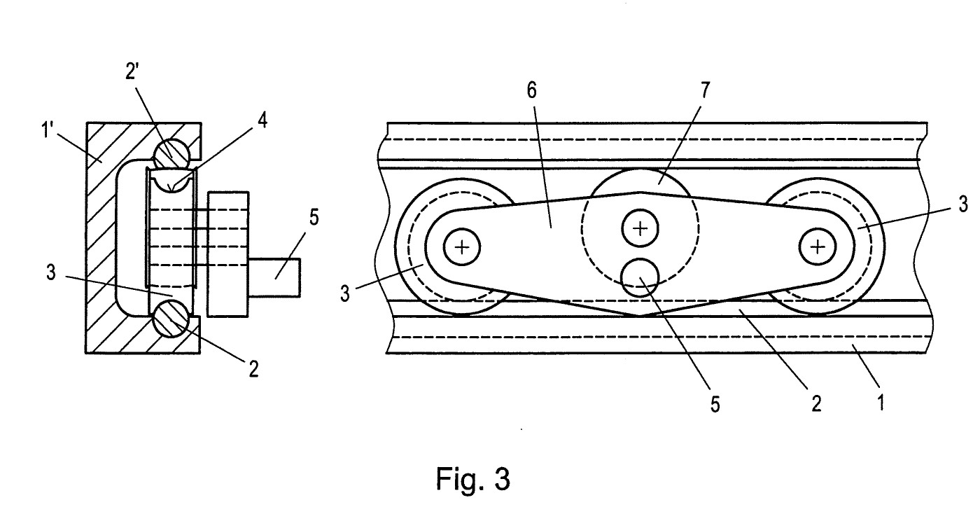

FIG. 2 shows a variant embodiment in which the supporting rail 1 is of symmetrical construction, i.e. two identical steel inserts 2 are provided lying opposite each other. This may be advantageous for stock keeping and orientation insensitivity during installation. It is of importance here for the adjustment roller 7 in this case to have a cylindrical or a slightly convex running surface so as not to cause any distortions during the angular offset.

FIG. 3 represents a further variant embodiment in which two cylindrical steel inserts 2 are likewise embedded in the supporting rail 1, wherein the steel insert 2′ serving as the adjustment surface has an adjustment surface which is flattened or is designed to be slightly concave. The kinematic situations as in FIG. 1 are again achieved in this respect, but the adjustment plate differs in shape.

The invention is not restricted to the exemplary embodiments illustrated and described that may be modified in different ways. It is thus also possible to use spring-mounted rollers made of plastic as the adjustment rollers or to mechanically design the roller rocker in such a manner that the bearing point for the adjustment roller is arranged on a roller rocker section which is connected to the actual roller rocker body only via a resilient web or the like.

The steel insert 2 does not have to be of circular design, but the part or section on which the steel insert serves as the contact surface for the supporting rollers should have a cross section in the shape of a circular arc in order to make the angular offset aimed for possible.

As explained further above, the arrangement of two supporting rollers 3 on each of the suspending points of the door leaf is one option; however, it is entirely possible to provide just one supporting roller and for the pre-stressing to be obtained either by a dedicated supporting roller or by a second suspending means which likewise consists of a supporting roller and an adjustment roller.

All of the materials or types of steel which are known and have proven worthwhile in the technical field of guide rails and bearing rollers are suitable as the material for the steel insert; given the knowledge of the invention and the particular field of application, a person skilled in the art in this field can easily select the appropriate materials from the customary materials.

1. A mechanism of configured to suspend a door leaf of a sliding door in rail-bound mass transportation vehicles, the mechanism comprising:
supporting rollers in a supporting rail configured in an upper region of a door leaf or above the door leaf, the supporting rollers being steel rollers having a concave cross-sectional shape on a running surface; and
a steel insert having at least a substantially circular track and being embedded in the supporting rail; and
an adjustment roller, the adjustment roller bearing under pre-stress against an adjustment surface of the supporting rail, the adjustment surface lying opposite the steel insert.

2. The mechanism of claim 1, wherein the steel insert has a circular cross section.

3. The mechanism of claim 1, wherein the adjustment surface is at least partially formed by the steel insert.

4. The mechanism of claim 1, wherein the adjustment surface has a concavely circular cross section, and a center point thereof coincides with a center point of a circular section of the running surface.

5. The mechanism of claim 1, wherein the adjustment roller is made of plastic.

6. The mechanism of claim 1, wherein the adjustment roller is mounted so as to be movable in the vertical direction so as to be under a force of a spring pressing the adjustment roller upward.
